(19) United States
(12) Patent Application Publication
(10) Pub. No.: US 2023/0083682 A1
(43) Pub. Date: Mar. 16, 2023

(54) TWO STEP RANDOM ACCESS PROCEDURE IN WIRELESS COMMUNICATION

(71) Applicant: QUALCOMM Incorporated, San Diego, CA (US)

(72) Inventors: Xiaoxia ZHANG, San Diego, CA (US); Changlong XU, Beijing (CN); Jing SUN, San Diego, CA (US); Ozcan OZTURK, San Diego, CA (US)

(21) Appl. No.: 17/800,862

(22) PCT Filed: Feb. 28, 2020
(86) PCT No.: PCT/CN2020/077123

§ 371 Date: Aug. 18, 2022

(51) Int. Cl. H04W 74/02; H04W 74/00

(52) U.S. Cl. CPC H04W 74/02; H04W 74/006

(57) ABSTRACT

Aspects of the present disclosure relate to a random access channel (RACH) procedure that allows a user equipment (UE) to achieve synchronization with a network and obtain network resources and services. The disclosure provides various options for implementing a two-step RACH procedure that can support various UE behaviors in relation to the monitoring of a physical downlink control channel (PDCCH) during the two-step RACH procedure.

### TECHNICAL FIELD

The technology discussed below relates generally to wireless communication systems, and more particularly, to random access procedures in wireless communication systems.

### BACKGROUND

Wireless communications systems are widely deployed to provide various types of communication content such as voice, video, packet data, messaging, broadcast, and so on. These systems may be accessed by various types of devices adapted to facilitate wireless communications, where multiple devices share the available system resources (e.g., time, frequency, and power). In a communication network, a user equipment (UE) may use a process called a random access (RA) procedure to acquire uplink synchronization and obtain specified network identification for obtaining radio access communication with a network.

As the demand for mobile broadband access continues to increase, research and development continue to advance wireless communication technologies not only to meet the growing demand for mobile broadband access, but to advance and enhance the user experience with mobile communications. For example, the third generation partnership project (3GPP) is an organization that develops telecommunication standards for 5G New Radio networks.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Aspects of the present disclosure relate to a random access channel (RACH) procedure that allows a user equipment (UE) to achieve synchronization with a network and obtain network resources and services. The disclosure provides various options for implementing a two-step RACH procedure that can support various UE behaviors in relation to the monitoring of a physical downlink control channel (PDCCH) during the two-step RACH procedure.

One aspect of the disclosure provides a method of wireless communication at a scheduled entity for a random access procedure. The scheduled entity transmits a first message to a scheduling entity in a random access procedure. The first message includes a physical random access channel (PRACH) preamble sequence for the random access procedure. If the first message includes information for determining a device-specific network identifier (e.g., C-RNTI) for the scheduled entity, the scheduled entity monitors a physical downlink control channel (PDCCH) for a second message transmitted by the scheduling entity in response to the first message, and the second message is scrambled by the device-specific network identifier for the scheduled entity.

Another aspect of the disclosure provides a method of wireless communication at a scheduled entity for a random access procedure. The scheduled entity transmits a first message to a scheduling entity in a random access procedure. The first message includes a PRACH preamble sequence for the random access procedure. The scheduled entity monitors, irrespective of whether the first message includes information for determining a device-specific network identifier for the scheduled entity, a PDCCH for a second message transmitted by the scheduling entity in response to the first message, and the second message is scrambled by the device-specific network identifier for the scheduled entity.

Another aspect of the disclosure provides a method of wireless communication at a scheduled entity for a random access procedure. The scheduled entity receives, from a scheduling entity, configuration information for configuring the scheduled entity in relation to the random access procedure. The scheduled entity transmits, to the scheduling entity, a first message comprising at least a PRACH preamble sequence for the random access procedure. The scheduled entity monitors, based on the configuration information, a PDCCH for a second message in response to the first message. The second message may be scrambled by a device-specific network identifier for the scheduled entity.

The configuration information may configure the scheduled entity to monitor the PDCCH for the second message, based on at least one of a type of random access procedure, a predetermined event of the random access procedure, a spectrum used for transmitting the first transmission, or a radio condition between the scheduled entity and the scheduling entity.

Another aspect of the disclosure provides a user equipment (UE) for wireless communication. The UE includes a communication interface configured for wireless communication with a scheduling entity, a memory, and a processor operatively coupled to the communication interface and the memory. The processor and the memory are configured to transmit, to the scheduling entity, a first message comprising a PRACH preamble sequence for a random access procedure. The processor and the memory are further configured to, if the first message includes information for determining a device-specific network identifier for the UE, monitor a PDCCH for a second message transmitted by the scheduling entity in response to the first message, and the second message is scrambled by the device-specific network identifier for the UE.

Another aspect of the present disclosure provides a user equipment (UE) for wireless communication. The UE includes a communication interface configured for wireless communication with a scheduling entity, a memory, and a processor operatively coupled to the communication interface and the memory. The processor and the memory are configured to transmit, to the scheduling entity, a first message comprising a PRACH preamble sequence for a random access procedure. The processor and the memory are further configured to monitor, irrespective of whether the first message includes information for determining a device-specific network identifier for the UE, a PDCCH for a second message transmitted by the scheduling entity in response to the first message, the second message scrambled by the device-specific network identifier for the UE.

Another aspect of the present disclosure provides a user equipment (UE) for wireless communication. The UE includes a communication interface configured for wireless communication with a scheduling entity, a memory, and a processor operatively coupled to the communication interface and the memory. The processor and the memory are configured to receive, from the scheduling entity, configuration information for configuring the UE in relation to a random access procedure. The processor and the memory are further configured to transmit, to the scheduling entity, a first message comprising at least a PRACH preamble sequence for the random access procedure. The processor and the memory are further configured to monitor, based on the configuration information, a PDCCH for a second message in response to the first message.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects of the present disclosure.

FIG. 2 is a conceptual illustration of an example of a radio access network according to some aspects of the present disclosure.

FIG. 3 is a flow diagram illustrating an example of a two-step random access procedure according to some aspects of the disclosure.

FIG. 4 is a block diagram conceptually illustrating an example of a hardware implementation for a scheduling entity according to some aspects of the disclosure.

FIG. 5 is a block diagram conceptually illustrating an example of a hardware implementation for a scheduled entity according to some aspects of the disclosure.

FIG. 6 is a flow chart illustrating a first exemplary process for a two-step random access procedure according to some aspects of the disclosure.

FIG. 7 is a flow chart illustrating a second exemplary process for a two-step random access procedure according to some aspects of the disclosure.

FIG. 8 is a flow chart illustrating a third exemplary process for a two-step random access procedure according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

Aspects of the present disclosure relate to a random access channel (RACH) procedure that allows a user equipment (UE) to achieve synchronization with a network and obtain network resources and services. The disclosure provides various options for implementing a two-step RACH procedure that can support various UE behaviors in relation to the monitoring of a physical downlink control channel (PDCCH) during the two-step RACH procedure.

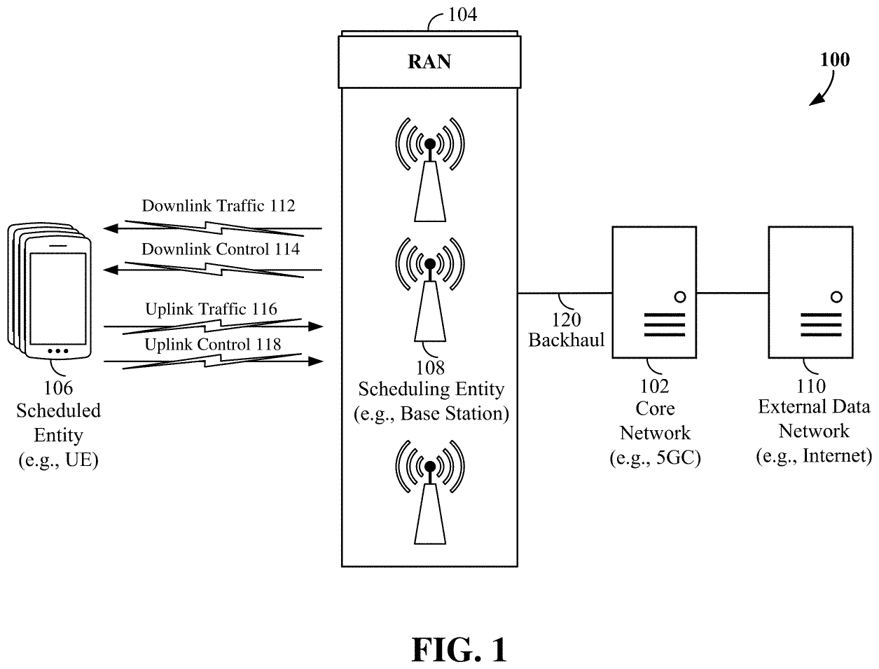

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

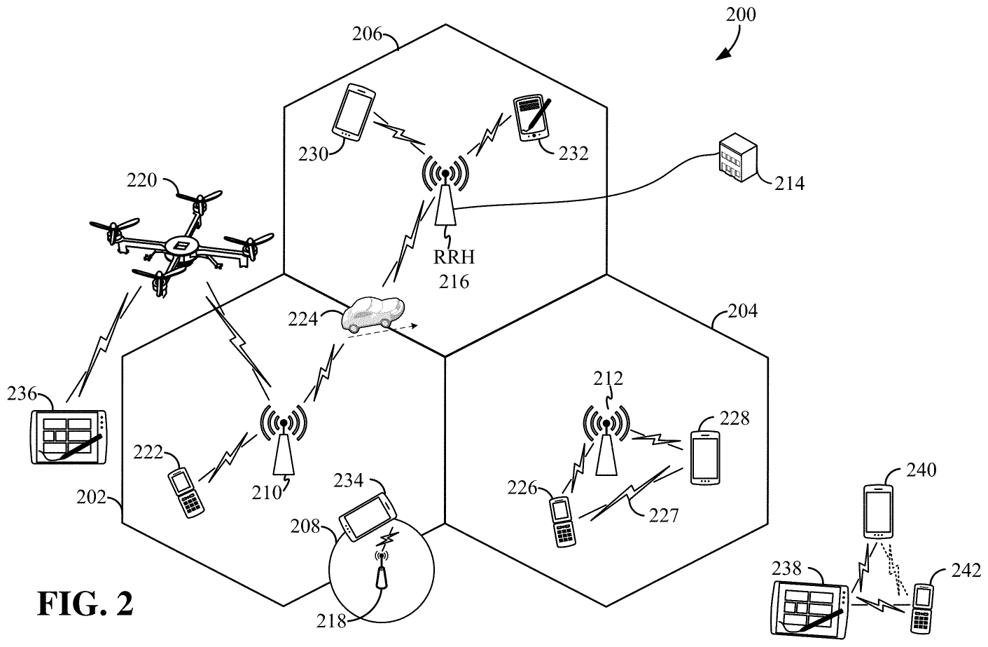

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In the radio access network 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

In various aspects of the disclosure, a radio access network 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. For example, 5G NR-based access to unlicensed spectrum (NR-U) may use unlicensed spectrum, for example, 5 GHz and 6 GHz bands. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the radio access network 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

In a downlink (DL) transmission, the transmitting device (e.g., the scheduling entity 108) may allocate one or more resource elements (REs) (e.g., time, frequency, and/or spatial resources) to carry DL control information 114 including one or more DL control channels that generally carry information originating from higher layers, such as a physical broadcast channel (PBCH), a physical downlink control channel (PDCCH), etc., to one or more scheduled entities 106. In addition, DL REs may be allocated to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc. The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity 106) may utilize one or more REs to carry UL control information 118 (UCI). The UCI can originate from higher layers via one or more UL control channels, such as a physical uplink control channel (PUCCH), a physical random access channel (PRACH), etc., to the scheduling entity 108. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the scheduling entity 108 to schedule uplink transmissions. Here, in response to the SR transmitted on the control channel 118, the scheduling entity 108 may transmit downlink control information 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In addition to control information, one or more REs may be allocated for user data or traffic data. Such traffic may be carried on one or more traffic channels, such as, for a DL transmission, a physical downlink shared channel (PDSCH); or for an UL transmission, a physical uplink shared channel (PUSCH).

In order for a UE to gain initial access to a cell, the RAN may provide system information (SI) characterizing the cell. This system information may be provided utilizing minimum system information (MSI), and other system information (OSI). The MSI may be periodically broadcast over the cell to provide the most basic information required for initial cell access, and for acquiring any OSI that may be broadcast periodically or sent on-demand. In some examples, the MSI may be provided over two different downlink channels. For example, the PBCH may carry a master information block (MIB), and the PDSCH may carry a system information block type 1 (SIB1). In the art, SIB1 may be referred to as the remaining minimum system information (RMSI). OSI may include any SI that is not broadcast in the MSI. In some examples, the PDSCH may carry a plurality of SIBs, not limited to SIB1, discussed above. Here, the OSI may be provided in these SIBs, e.g., SIB2 and above.

The channels or carriers described above and illustrated in FIGS. 1 and 2 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

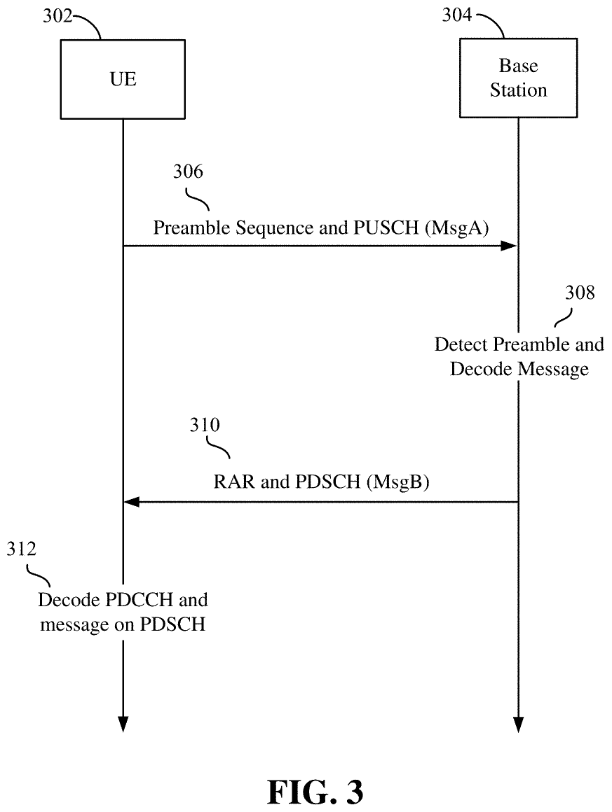

FIG. 3 is a flow diagram illustrating an example of a two-step RACH procedure according to some aspects of the disclosure. This two-step RACH procedure may be implemented as a contention-based RACH procedure or contention-free RACH procedure. In this example, a UE 302 is shown communicating with a base station 304 using a licensed or shared/unlicensed spectrum. When using a shared or unlicensed spectrum, the UE may use a listen-before-talk (LBT) procedure to determine whether or not another device is using the same spectrum before the UE transmits a RACH message. It should be understood that aspects of the disclosure can be employed between a scheduled entity (e.g., UE 302) and a scheduling entity (e.g., base station 304 or gNB).

As shown, the UE 302 transmits a first message (e.g., MsgA 306) to the base station 304. The MsgA 306 transmission may include PRACH and PUSCH transmissions, respectively. The PRACH transmission may include a PRACH preamble sequence. In one example of a contention-based RACH procedure, the UE may select a PRACH preamble sequence from a set of available preamble sequences. In another example of a contention-free RACH procedure, the base station 304 may assign a PRACH preamble to the UE. In some examples, the MsgA PUSCH transmission may include a radio network temporary identifier (RNTI) and/or other information. In some examples, the PUSCH may include information associated with a cell RNTI (C-RNTI) that is specific to the UE. The base station 304 may use the C-RNTI in subsequent transmissions addressed to the UE 302. For example, the base station may scramble a PDCCH for the UE with the C-RNTI specific to the UE.

When the base station 304 receives MsgA 306, the base station 304 detects the PRACH preamble at step 308. If MsgA 306 transmission received by the base station 304 includes the PUSCH information, the base station 304 may decode the PUSCH at step 308. In some cases, the UE may fail to transmit PUSCH due to, for example, invalid PUSCH resources (e.g., PUSCH occasions) and/or listen-before-talk (LTB) failure in shared spectrum applications. In response to MsgA 306, the base station 304 can send a second message (e.g., MsgB 310) to the UE 302 in this two-step RACH procedure. MsgB 310 may include, for example, a random-access response (RAR). In a contention-based RACH example, MsgB 310 may also include a contention resolution message in a PDSCH.

The UE may monitor the PDCCH for the RAR that may be identified by an RNTI. In one example, the RNTI may be an MsgB-RNTI that can be determined or computed based on the resources (e.g., PRACH occasions) used by UE to transmit MsgA 306. PRACH occasions are time-frequency resources allocated by the network for transmitting the PRACH. In another example, the RNTI may be the C-RNTI when C-RNTI information (e.g., the C-RNTI or information from which the C-RNTI may be derived) is included in the MsgA PUSCH transmission. For example, if the base station receives the C-RNTI information in MsgA 306, the PDCCH in MsgB 310 may include CRC bits that are scrambled with the C-RNTI specific to the UE. MsgB 310 may further include a message transmitted in the PDSCH. The message transmitted in the PDSCH may include UE-specific content, such as an indication confirming the PRACH preamble, a timing advance value, a back-off indicator, a contention resolution message, a transmit power control (TPC) command, an uplink or downlink resource grant, and/or other information. On receipt of the second message (MsgB 310), the UE 302 attempts to decode the PDCCH and the PDSCH at step 312.

In one example, the UE 302 and base station 304 may generate a device-specific network identifier associated with the UE (e.g., C-RNTI) based on an identity of the UE (UE ID). For example, the UE and base station may utilize a predetermined number of bits of the UE identity (UE ID) as the device-specific network identifier or may derive the device-specific network identifier from the predetermined number of bits of the UE ID. Referring again to FIG. 3, when the UE 302 includes the UE ID, or at least a portion of the UE ID, in the first message 306, the base station 304 can determine from the UE ID a device-specific network identifier (e.g., C-RNTI) in the same manner that the UE 302 determines a device-specific network identifier (e.g., C-RNTI) from the UE ID. In this way, both entities may be aware of the device-specific network identifier to be associated with the UE 302.

In another example, the UE 302 and base station 304 can generate the device-specific network identifier (e.g., C-RNTI) based on one or more resource parameters associated with the resources utilized to send the first message 306. For example, the resource parameters associated with the resources utilized to send the first message (Msg A 306) may include the transmission time, the frequency, the preamble sequence (e.g., the root, shifts), etc. The UE 302 and the base station 304 may utilize one or more of these resource parameters to generate the device-specific network identifier for use by the UE 302 as part of the random access procedure.

In another example, the UE 302 and base station 304 can generate the device-specific network identifier (e.g., C-RNTI) based on a combination of at least a portion of the UE ID and one or more resource parameters associated with the resources selected for sending the first message 306. For instance, the UE-specific network identifier may be generated by mapping at least a portion of the UE ID and one or more resource parameters associated with the resources selected for sending the first message 306 to the device-specific network identifier. In this example, the resources for sending the first message 306 may be selected randomly, similar to the example described with reference to FIG. 3. Alternatively, the one or more resource parameters for transmitting the first message 306 may be selected based on a predetermined number of bits from the UE ID. Additional bits of the UE ID may also be transmitted in the first message 306. Utilizing both the UE ID payload and the one or more resource parameters associated with the resources utilized for sending the first message 306, the UE 302 and base station 304 can derive the device-specific network identifier that is unique to the UE 302.

When the above-described two-step RACH procedure is used with unlicensed or shared spectrum, there is a possibility that the PRACH is transmitted while the PUSCH of MsgA is not transmitted due to, for example, invalid PUSCH resources and/or listen-before-talk (LBT) failure. In this situation, the UE may not monitor for the MsgB PDCCH (e.g., DCI format 1_0 with a CRC scrambled by C-RNTI) if the UE has failed to transmit the PUSCH of MsgA. In some examples, the UE may not monitor for the MsgB PDCCH when the UE has failed to transmit the PUSCH of MsgA in a two-step contention-based RACH procedure (CBRA). When the UE does not transmit or fails to transmit MsgA PUSCH including C-RNTI information, the base station (e.g., gNB) may not be able to obtain the C-RNTI of the UE in the MsgA transmission. As a result, the base station may transmit a random access response in the PDCCH of MsgB with a CRC that is not scrambled by the C-RNTI of the UE.

However, the above-described scenario may not apply in a two-step contention-free RACH procedure (CFRA) that may be used in a 5G NR network. In CFRA, the network (e.g., base station) may allocate different PRACH preambles to different UEs to avoid PRACH collision. In this case, even if the UE fails to transmit the MsgA PUSCH, there is still the possibility that the base station (e.g., gNB) can determine the identity of the UE that has successfully transmitted only the PRACH preamble. As a result, the base station can still transmit a random access response scrambled by the C-RNTI of the UE even when the UE has failed to transmit the C-RNTI information in MsgA.

Aspects of the present disclosure provide various options for configuring UE behavior in a two-step RACH procedure using a contention-free RACH procedure (CFRA) or a contention-based RACH procedure (CBRA).

In one example, a UE monitors the MsgB PDCCH for a random access response (RAR) identified by the C-RNTI only if the UE actually has transmitted the MsgA PUSCH that includes C-RNTI information (e.g., a C-RNTI MAC (control element) CE). If the UE has not transmitted the C-RNTI information, the UE may monitor the random access response identified by the MsgB-RNTI. In some examples, the UE may monitor for the RAR in a special cell (SpCell), which may correspond to the primary cell of a master cell group (MSG) or the primary secondary cell of a secondary cell group (SCG) depending on whether the MAC entity is associated with the MCG or the SCG.

This UE behavior may be used when the UE is in licensed and/or unlicensed spectrum operations. In a licensed spectrum operation, the PUSCH resources may be invalid or unavailable for transmitting the PUSCH. As a result, the UE only transmits the PRACH, but not PUSCH. In an unlicensed spectrum operation, the UE may not transmit MsgA PUSCH, for example, due to invalid PUSCH resources and/or LBT failure for PUSCH transmission. In CBRA applications, the UE overhead may be reduced by not monitoring for the MsgA PDCCH scrambled with the C-RNTI. In CFRA applications, however, if the UE does not monitor for the MsgA PDCCH, the UE may not receive the RAR that is identified by the PDCCH scrambled with C-RNTI when the base station can determine the C-RNTI even though the UE has not transmitted the MsgA PUSCH.

In another example, as long as the UE includes C-RNTI information (e.g., C-RNTI MAC CE) in the data for transmission as MsgA PUSCH, the UE monitors the MsgB PDCCH of the SpCell for a random access response identified by the C-RNTI irrespective of whether the UE actually transmits the PUSCH including the C-RNTI information (e.g., due to LBT failure or invalid PUSCH resources). In CFRA applications, this implementation allows the UE to receive the RAR within the PDCCH scrambled with C-RNTI even when the UE has not transmitted the MsgA PUSCH. In CBRA applications, however, the UE may unnecessarily monitor for the PDCCH scrambled by C-RNTI as the base station is not able to transmit the PDCCH scrambled by the C-RNTI without receiving the C-RNTI information in MsgA. In one example, as a UE implementation, the UE may choose not to monitor the PDCCH scrambled by C-RNTI when the UE has not actually transmitted the MsgA PUSCH that includes the C-RNTI MAC CE. In this case, not monitoring the PDCCH should have no significant consequence because the base station (e.g., gNB) will not be able to transmit the PDCCH scrambled by C-RNTI regardless as the UE has not transmitted its C-RNTI information (e.g., C-RNTI MAC CE).

In another example, the UE may have different behavior in CBRA and CFRA. In CBRA, the UE monitors the PDCCH of the SpCell for the random access response (RAR) identified by the C-RNTI only when the UE actually has transmitted the MsgA PUSCH that includes the C-RNTI MAC CE. In CFRA, the UE monitors the PDCCH identified by the C-RNTI irrespective of the MsgA PUSCH transmission success or failure. For example, the UE may include the C-RNTI information for transmission in the PUSCH of MsgA, but the UE may only transmit the PRACH portion of MsgA without the PUSCH that includes the C-RNTI information for reasons noted above.

In another example, the base station (e.g., gNB) can configure different UE PDCCH monitoring behavior in various configurations. In one example, the base station may configure a UE to monitor the MsgB PDCCH identified by the C-RNTI even when the UE has failed to transmit the MsgA PUSCH for CFRA. In another example using CBRA, the base station may configure the UE to monitor the MsgB PDCCH identified by the C-RNTI when the base station intends to transmit a random access response (RAR) identified by the C-RNTI. In this example, the base station may obtain knowledge of the UE's C-RNTI via PUSCH detection of MsgA or PRACH occasions used for transmitting MsgA. In another example, if the base station has not configured the UE to monitor the PDCCH identified by the C-RNTI, the UE may instead monitor for MsgB-RNTI in the PDCCH. In some examples, the configuration can be specific to UEs using a shared spectrum or to UEs using both licensed and shared spectrum. The configuration can also limit the usage of PDCCH C-RNTI monitoring for certain RACH events (e.g., handover, beam failure recovery (BFR)) and/or radio conditions (e.g., when reference signal receive power (RSRP) is higher than a predetermined threshold and/or for certain beams).

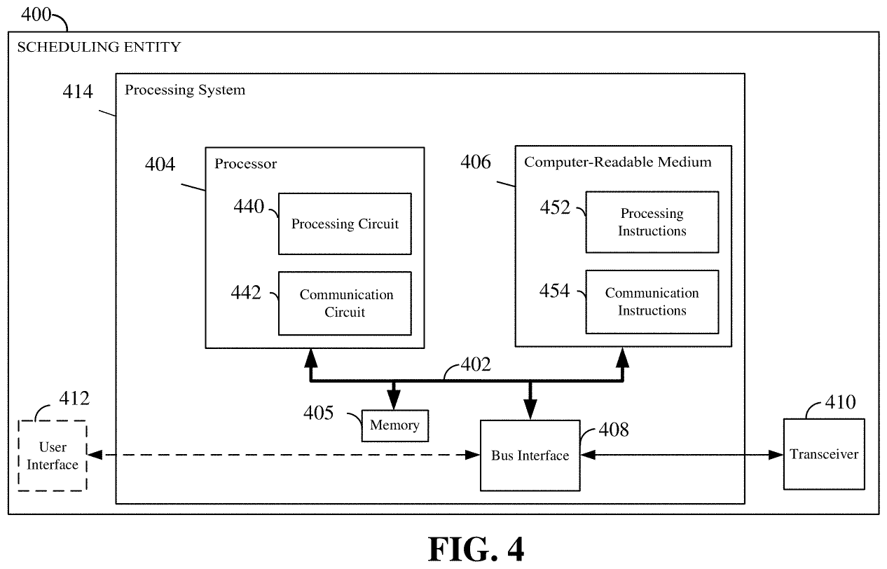

FIG. 4 is a block diagram illustrating an example of a hardware implementation for a scheduling entity 400 employing a processing system 414. For example, the scheduling entity 400 may be a user equipment (UE) as illustrated in any one or more of FIGS. 1, and/or 2. In another example, the scheduling entity 400 may be a base station as illustrated in any one or more of FIGS. 1, 2, and/or 3.

The scheduling entity 400 may be implemented with a processing system 414 that includes one or more processors 404. Examples of processors 404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 400 may be configured to perform any one or more of the functions described herein. That is, the processor 404, as utilized in a scheduling entity 400, may be used to implement any one or more of the processes and procedures described and illustrated in the included drawings.

In this example, the processing system 414 may be implemented with a bus architecture, represented generally by the bus 402. The bus 402 may include any number of interconnecting buses and bridges depending on the specific application of the processing system 414 and the overall design constraints. The bus 402 communicatively couples together various circuits including one or more processors (represented generally by the processor 404), a memory 405, and computer-readable media (represented generally by the computer-readable medium 406). The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a communication interface or means for communicating with various other apparatus over a transmission medium. Depending upon the nature of the apparatus, a user interface 412 (e.g., keypad, display, speaker, microphone, joystick) may also be provided. Of course, such a user interface 412 is optional, and may be omitted in some examples, such as a base station.

In some aspects of the disclosure, the processor 404 may include circuitry configured for various functions, for example, random access procedure. For example, the circuitry may be configured to implement one or more of the functions described throughout this disclosure in relation to the included drawings, including FIGS. 3-7. The circuitry may include a processing circuit 440 and a communication circuit 442. The processing circuit 440 may be configured to perform various data processing functions and algorithms, including those used to implement the various concepts and designs described in this disclosure. The communication circuit 442 may be configured to perform various communication functions and algorithms including those used to implement the various concepts and designs described in this disclosure.

The processor 404 is responsible for managing the bus 402 and general processing, including the execution of software stored on the computer-readable medium 406. The software, when executed by the processor 404, causes the processing system 414 to perform the various functions described below for any particular apparatus. The computer-readable medium 406 and the memory 405 may also be used for storing data that is manipulated by the processor 404 when executing software.

One or more processors 404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 406. The computer-readable medium 406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 406 may reside in the processing system 414, external to the processing system 414, or distributed across multiple entities including the processing system 414. The computer-readable medium 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 406 may include software (e.g., processing instructions 452 and communication instructions 454) configured for various functions. For example, the software may be configured to implement one or more of the functions for a random access procedure described throughout this disclosure in relation to the included drawings, for example, FIGS. 3-7.

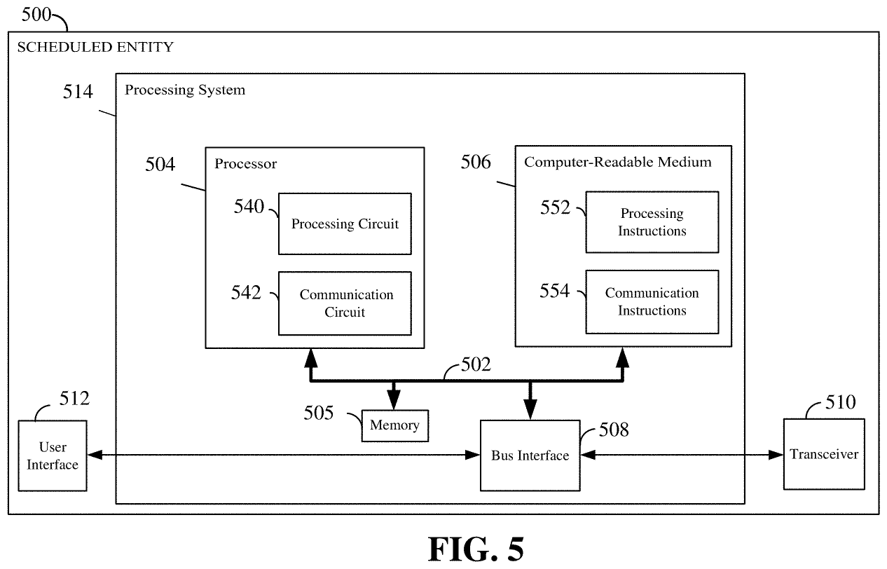

FIG. 5 is a conceptual diagram illustrating an example of a hardware implementation for an exemplary scheduled entity 500 employing a processing system 514. In accordance with various aspects of the disclosure, an element, or any portion of an element, or any combination of elements may be implemented with a processing system 514 that includes one or more processors 504. For example, the scheduled entity 500 may be a user equipment (UE) as illustrated in any one or more of FIGS. 1, 2, and/or 3.

The processing system 514 may be substantially the same as the processing system 414 illustrated in FIG. 4, including a bus interface 508, a bus 502, memory 505, a processor 504, and a computer-readable medium 506. Furthermore, the scheduled entity 500 may include a user interface 512 and a transceiver 510 substantially similar to those described above in FIG. 4. That is, the processor 504, as utilized in a scheduled entity 500, may be used to implement any one or more of the processes described in this disclosure and illustrated in the included drawings. In some aspects of the disclosure, the processor 504 may include circuitry configured for various functions. For example, the circuitry may be configured to implement one or more of the functions described in this disclosure in relation to the included drawings. The circuitry may include a processing circuit 540 and a communication circuit 542. The processing circuit 540 may be configured to perform various data processing functions and algorithms for a random access procedure, including those used to implement the various concepts and designs described in this disclosure. The communication circuit 542 may be configured to perform various functions and algorithms used for wireless communication and a random access procedure. In one or more examples, the computer-readable storage medium 506 may include software (e.g., processing instructions 552 and communication instructions 554) configured for various functions. For example, the software may be configured to implement one or more of the functions and algorithms for a random access procedure described throughout this disclosure in relation to the included drawings.

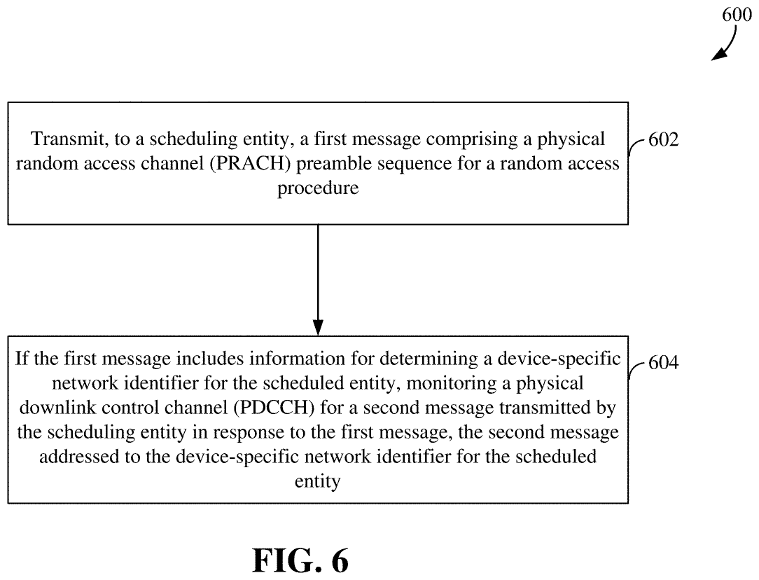

FIG. 6 is a flow chart illustrating an exemplary process 600 for a two-step random access procedure in accordance with some aspects of the present disclosure. As described below, some or all illustrated features may be omitted in a particular implementation within the scope of the present disclosure, and some illustrated features may not be required for the implementation of all embodiments. In some examples, the process 600 may be carried out by the scheduled entity 500 illustrated in FIG. 5. In some examples, the process 600 may be carried out by any suitable apparatus or means for carrying out the functions or algorithms described below.

At block 602, a scheduled entity (e.g., UE 302) transmits a first message to a scheduling entity. The first message includes a physical random access channel (PRACH) preamble sequence for a random access procedure. For example, the scheduled entity may use the processing circuit 540 to prepare the data to be included in the first message. The first message may be, for example, MsgA 306 of a two-step random access procedure. The first message may also include a PUSCH including information for determining a device-specific network identifier for the scheduled entity. In one example, the device-specific network identifier may be a C-RNTI or other suitable device-specific network identifier. In one example, the first message may include a C-RNTI MAC CE. However, in some cases, the scheduled entity may fail to transmit the C-RNTI MAC CE in a PUSCH in the first message even if the scheduled entity has included the information of C-RNTI MAC CE in the data to be transmitted as the first message (e.g., due to LBT failure or invalid PUSCH resources). The scheduled entity may use the communication circuit 542 to transmit the first message via the transceiver 510 using communication resources allocated for the random access procedure (e.g., PRACH occasions and PUSCH occasions).

At block 604, the scheduled entity monitors, from the scheduling entity, a physical downlink control channel (PDCCH) for a second message in response to the first message, if the first message includes information for determining the device-specific network identifier (e.g., C-RNTI) for the scheduled entity. The second message may be scrambled by the device-specific network identifier for the scheduled entity. For example, the second message may be MsgB 310 of the two-step random access procedure. The scheduled entity may use the communication circuit 542 to monitor the PDCCH for the second message via the transceiver 510.

In one example, the scheduled entity may determine that the first message includes the C-RNTI information if the scheduled entity has actually transmitted the PUSCH including the C-RNTI MAC CE.

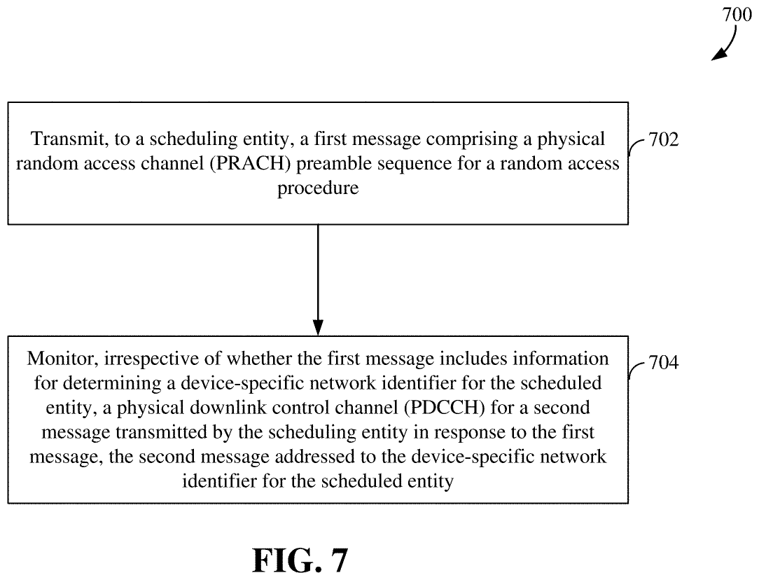

FIG. 7 is a flow chart illustrating an exemplary process 700 for a two-step random access procedure in accordance with some aspects of the present disclosure. As described below, some or all illustrated features may be omitted in a particular implementation within the scope of the present disclosure, and some illustrated features may not be required for the implementation of all embodiments. In some examples, the process 700 may be carried out by the scheduled entity 500 illustrated in FIG. 5. In some examples, the process 700 may be carried out by any suitable apparatus or means for carrying out the functions or algorithms described below.

At block 702, a scheduled entity (e.g., UE 302) transmits a first message to a scheduling entity. The first message includes a physical random access channel (PRACH) preamble sequence for a random access procedure. For example, the scheduled entity may use the processing circuit 540 to prepare data to be transmitted as the first message. The first message may be, for example, MsgA 306 of a two-step random access procedure. The first message may also include a PUSCH including information for determining a device-specific network identifier for the scheduled entity. In one example, the device-specific network identifier may be a C-RNTI or other suitable device-specific network identifier. In one example, the data to be transmitted as the first message may include a C-RNTI MAC CE. The scheduled entity may use the communication circuit 542 to transmit the first message via the transceiver 510 using communication resources allocated for the random access procedure (e.g., PRACH occasions and PUSCH occasions). However, in some cases, the scheduled entity may fail to transmit the C-RNTI information in a PUSCH in the first message.

At block 704, the scheduled entity monitors, from the scheduling entity, a physical downlink control channel (PDCCH) for a second message in response to the first message, irrespective of whether the first message includes information for determining the device-specific network identifier (e.g., C-RNTI) for the scheduled entity. For example, the scheduled entity may include the C-RNTI information in the PUSCH data for the transmission of the first message. In this case, the scheduled entity may successfully transmit the PRACH portion of the first message, but the scheduled entity failed to transmit the PUSCH including the C-RNTI information due to invalid PUSCH resources and/or LBT failure. In one example, the scheduled entity monitors the PDCCH for the second message whether or not the first message includes a C-RNTI MAC CE for determining the device-specific network identifier for the scheduled entity. The second message may be scrambled by the device-specific network identifier for the scheduled entity. For example, the second message may be MsgB 310 of the two-step random access procedure. The scheduled entity may use the communication circuit 542 to monitor the PDCCH for the second message via the transceiver 510.

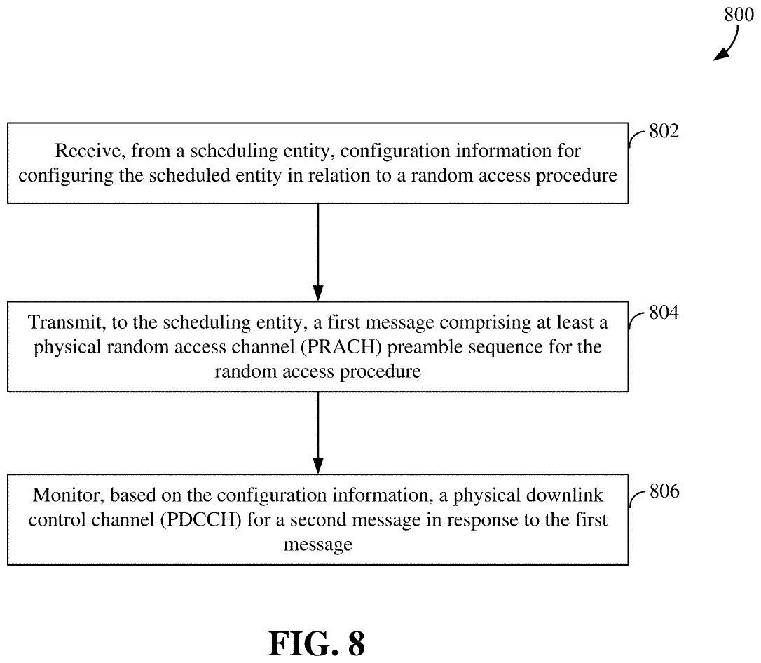

FIG. 8 is a flow chart illustrating an exemplary process 800 for a two-step random access procedure in accordance with some aspects of the present disclosure. As described below, some or all illustrated features may be omitted in a particular implementation within the scope of the present disclosure, and some illustrated features may not be required for the implementation of all embodiments. In some examples, the process 800 may be carried out by the scheduled entity 500 illustrated in FIG. 5. In some examples, the process 800 may be carried out by any suitable apparatus or means for carrying out the functions or algorithms described below.

At block 802, the scheduled entity (e.g., UE 302) receives, from a scheduling entity (e.g., base station 304), configuration information for configuring the scheduled entity in relation to a random access procedure. The configuration information configures the scheduled entity's behavior during the random access procedure. For example, the scheduled entity may use the communication circuit 542 to receive the configuration information via the transceiver 510. In one example, the configuration information may be included in a radio resource control (RRC) configuration received from the scheduling entity (e.g., base station 304).

At block 804, the scheduled entity transmits a first message for the random access procedure to the scheduling entity. The first message includes at least a physical random access channel (PRACH) preamble sequence for the random access procedure. For example, the first message may be the first message (e.g., MsgA 306) of a two-step random access procedure. In one example, the scheduled entity may use the processing circuit 540 to prepare the data to be transmitted as the first message. The scheduled entity may use the communication circuit 542 to transmit the first message via the transceiver 510 using communication resources (e.g., PRACH occasions and PUSCH occasions) allocated for the random access procedure. The first message may or may not include the information for determining a device-specific network identifier for the scheduled entity. For example, the scheduled entity may include C-RNTI MAC CE in the data to be transmitted as the first message. However, in some cases, the scheduled entity may fail to transmit the C-RNTI MAC CE in a PUSCH of the first message, for example, due to invalid PUSCH resources and/or LBT failure in a shared spectrum.

At block 806, the scheduled entity monitors, based on the configuration information, a PDCCH for a second message in response to the first message. For example, the scheduled entity may use the communication circuit 542 to monitor the PDCCH for the second message that may be scrambled by a device-specific network identifier (e.g., C-RNTI) for the scheduled entity or the MsgB-RNTI. For example, the second message may be MsgB 310 of a two-step random access procedure. The scheduled entity may use the communication circuit 542 to monitor the PDCCH for the second message via the transceiver 510.

In one example, the configuration information may configure the scheduled entity to monitor the PDCCH for the second message scrambled by the device-specific network identifier for the scheduled entity, whether or not the transmitted first message actually includes the information (e.g., C-RNTI MAC CE) for determining the device-specific network identifier (e.g., C-RNTI) for the scheduled entity.

In one example, the configuration information may configure the scheduled entity to monitor the PDCCH for the second message scrambled by the device-specific network identifier (e.g., C-RNTI) for the scheduled entity, based on at least one of a type of random access procedure (e.g., CBRA or CFRA), a predetermined event of the random access procedure, a spectrum used for transmitting the first transmission, or a radio condition between the scheduled entity and the scheduling entity. Examples of a predetermined event of the random access procedure may include handover and beam failure recovery. In some examples, the configuration information may be used only for CBRA. In some examples, the configuration information may be used for both licensed and shared spectrum cases.

In one configuration, the apparatus 400 and/or 500 for wireless communication each includes various means for performing the various functions, processes, and procedures described in this disclosure. In one aspect, the aforementioned means may be the processor 404/504 shown in FIG. 4/5 configured to perform the functions recited by the aforementioned means. In another aspect, the aforementioned means may be a circuit or any apparatus configured to perform the functions recited by the aforementioned means.

Of course, in the above examples, the circuitry included in the processor 404/504 is merely provided as an example, and other means for carrying out the described functions may be included within various aspects of the present disclosure, including but not limited to the instructions stored in the computer-readable storage medium 406/506, or any other suitable apparatus or means described in any one of the FIGS. 1, 2, and/or 3, and utilizing, for example, the processes and/or algorithms described herein in relation to FIGS. 3, 6, and/or 7.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-7 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-7 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication at a scheduled entity, comprising:
transmitting, to a scheduling entity, a first message comprising a physical random access channel (PRACH) preamble sequence for a random access procedure; and
if the first message includes information for determining a device-specific network identifier for the scheduled entity, monitoring a physical downlink control channel (PDCCH) for a second message transmitted by the scheduling entity in response to the first message, the second message scrambled by the device-specific network identifier for the scheduled entity.

2. The method of claim 1, wherein the first message comprises a physical uplink shared channel (PUSCH) transmission including the information for determining the device-specific network identifier for the scheduled entity.

3. The method of claim 1, wherein the random access procedure comprises a contention-based random access procedure.

4. A method of wireless communication at a scheduled entity, comprising:
transmitting, to a scheduling entity, a first message comprising a physical random access channel (PRACH) preamble sequence for a random access procedure; and
monitoring, irrespective of whether the first message includes information for determining a device-specific network identifier for the scheduled entity, a physical downlink control channel (PDCCH) for a second message transmitted by the scheduling entity in response to the first message, the second message scrambled by the device-specific network identifier for the scheduled entity.

5. The method of claim 4, wherein the random access procedure comprises a contention-free random access procedure.

6. The method of claim 4, wherein the first message fails to include a physical uplink shared channel (PUSCH) comprising the information for determining the device-specific network identifier for the scheduled entity.

7. A method of wireless communication at a scheduled entity, comprising:
receiving, from a scheduling entity, configuration information for configuring the scheduled entity in relation to a random access procedure;
transmitting, to the scheduling entity, a first message comprising at least a physical random access channel (PRACH) preamble sequence for the random access procedure; and
monitoring, based on the configuration information, a physical downlink control channel (PDCCH) for a second message in response to the first message.

8. The method of claim 7, wherein the configuration information configures the scheduled entity to monitor the PDCCH for the second message scrambled by a device-specific network identifier for the scheduled entity, irrespective of whether the first message comprises information for determining the device-specific network identifier for the scheduled entity.

9. The method of claim 7, wherein the configuration information configures the scheduled entity to monitor the PDCCH for the second message scrambled by a device-specific network identifier for the scheduled entity, based on at least one of a type of random access procedure, a predetermined event of the random access procedure, a spectrum used for transmitting the first transmission, or a radio condition between the scheduled entity and the scheduling entity.

10. A user equipment (UE) of wireless communication comprising:
a communication interface configured for wireless communication with a scheduling entity;
a memory; and
a processor operatively coupled to the communication interface and the memory,
wherein the processor and the memory are configured to:
transmit, to the scheduling entity, a first message comprising a physical random access channel (PRACH) preamble sequence for a random access procedure; and
if the first message includes information for determining a device-specific network identifier for the UE, monitor a physical downlink control channel (PDCCH) for a second message transmitted by the scheduling entity in response to the first message, the second message scrambled by the device-specific network identifier for the UE.

11. The UE of claim 10, wherein the first message comprises a physical uplink shared channel (PUSCH) transmission including the information for determining the device-specific network identifier for the UE.

12. The UE of claim 10, wherein the random access procedure comprises a contention-based random access procedure.

13. A user equipment (UE) for wireless communication comprising:
a communication interface configured for wireless communication with a scheduling entity;
a memory; and
a processor operatively coupled to the communication interface and the memory,
wherein the processor and the memory are configured to:
transmit, to the scheduling entity, a first message comprising a physical random access channel (PRACH) preamble sequence for a random access procedure; and
monitor, irrespective of whether the first message includes information for determining a device-specific network identifier for the UE, a physical downlink control channel (PDCCH) for a second message transmitted by the scheduling entity in response to the first message, the second message scrambled by the device-specific network identifier for the UE.

14. The UE of claim 13, wherein the random access procedure comprises a contention-free random access procedure.

15. The UE of claim 13, wherein the first message fails to include a physical uplink shared channel (PUSCH) comprising the information for determining the device-specific network identifier for the UE.

16. A user equipment (UE) for wireless communication comprising:
a communication interface configured for wireless communication with a scheduling entity;
a memory; and
a processor operatively coupled to the communication interface and the memory,
wherein the processor and the memory are configured to:
receive, from the scheduling entity, configuration information for configuring the UE in relation to a random access procedure;
transmit, to the scheduling entity, a first message comprising at least a physical random access channel (PRACH) preamble sequence for the random access procedure; and
monitoring, based on the configuration information, a physical downlink control channel (PDCCH) for a second message in response to the first message.

17. The UE of claim 16, wherein the configuration information configures the UE to monitor the PDCCH for the second message scrambled by a device-specific network identifier for the UE, irrespective of whether the first message comprises information for determining the device-specific network identifier for the UE.

18. The UE of claim 16, wherein the configuration information configures the UE to monitor the PDCCH for the second message scrambled by a device-specific network identifier for the UE, based on at least one of a type of random access procedure, a predetermined event of the random access procedure, a spectrum used for transmitting the first transmission, or a radio condition between the UE and the scheduling entity.
